(19) United States
(12) Patent Application Publication
(10) Pub. No.: US 2007/0153283 A1
(43) Pub. Date: Jul. 5, 2007

(54) Surface plasmon resonance detector

(75) Inventors: Yu-Chia Tsao, Taipei City (TW); Woo-Hu Tsai, Taipei City (TW); Hong-Yu Lin, Taipei City (TW); Jung-Chien Chang, Taoyuan City (TW)

Correspondence Address: BACON & THOMAS, PLLC, 625 SLATERS LANE, FOURTH FLOOR, ALEXANDRIA, VA, 22314, US

(73) Assignee: Forward Electronics Co., Ltd., Taipei City (TW)

(21) Appl. No.: 11/484,643

(22) Filed: Jul. 12, 2006

(30) Foreign Application Priority Data
Jan. 3, 2006 (TW) 095100191

(51) Int. Cl. G01N 21/55

(52) U.S. Cl. 356/445

(57) ABSTRACT

The present invention relates to a surface plasmon resonance detector, that is portable and easy to operate, and its optical-fiber biosensor unit can be readily replaced. The SPR detector of the present invention comprises: a light source; an optical-fiber biosensor unit having a well, a coating layer, and a core layer; an optical detector; a plurality of optical fibers connecting with the light source, the optical-fiber biosensor unit and the optical detector; and a calculation and display unit connecting with the optical detector, wherein the optical detector receives the optical signals from the optical detector and display the calculation results thereof. Besides, the SPR detector of the present invention has high sensitivity and is able to identify species of trace biomolecules.

### BACKGROUND OF THE INVENTION

1. Field of the Invention

The present invention relates to a surface plasmon resonance detector and, more particularly, to a surface plasmon resonance detector that is portable and easy to operate, while it is easy to change the biosensor unit thereof.

2. Description of Related Art

For applications in medical and environmental detection, it is essential to identify the species and concentrations of the biomolecules rapidly and accurately. Such as in environmentally hazardous occasions, the responding staff must first identify the species and the concentrations of the harmful materials at the site, so as to decide the subsequent procedures of treatment according to the detection results and minimize the risks of the treatment. Thus, accuracy, sensitivity, simplicity in operation procedures and portability are important.

To date, Surface Plasmon Resonance (SPR) detectors based on surface plasmon resonance effects have been employed by the industry to detect the species and the concentrations of the biomolecules to be traced. The SPR detectors possess has the following advantages: a. minimal time is required for detection; b. the sample is label-free during the detection process; c. minimal amount of the sample is required; d. detecting the interactions between the sample and the ligands thereof in real-time; and, e. high detection sensitivity.

FIG. 1 is a schematic illustration of prior art SPR detectors, comprising an incident light source 11, an incident light treatment unit 12, a prism 13, a metal layer 14, an optical detector 15, a detecting target loading unit 16 and a spectrometer 17, wherein the light source 11 is a laser diode, and the incident light treatment unit 12 further comprising a beam amplifier 121, a polarizer 122, a spectroscope 123 and a focus lens. Therefore, after light generated by the light source 11 passes through the incident light treatment unit 12, it has certain frequency, mode and polarization, which is suitable to be used in the detection process. Besides, the metal layer 14 is formed on the back surface of prism 13 by depositing gold or silver particles, either by vapor deposition or sputtering. In the course of detection, the light generated by the light source 11 first passes through light treatment unit 12 and then enters a first side 131 of the prism 13. The light is reflected by the metal layer 14, then emitting from a second side 132 of prism 13, and entering the optical detector 16. Finally, the optical signals received by the optical detector 16 are corresponding converted to electrical signals which are provided to spectrometer 17 for analysis of the spectrum profiles thereof.

However, the size of this kind of SPR detector is huge, and the locations of the components relative to each other must be maintained accurately, or the light emitting from the incidence light treatment unit will not be correctly reflected by the metal layer formed on the back surface of the prism, and the light will not reach the optical detector. Therefore, the SPR detectors have low tolerance to vibrations and are easily damaged by collision, rendering it inappropriate for bringing to the impacted sites by the responding staff.

Therefore, an SPR detector that is portable and easy to operate, and the optical-fiber biosensor unit thereof can be changed readily, allowing the responding staff to bring the same to the impacted sites and proceed with accurate detection is required.

### SUMMARY OF THE INVENTION

The SPR detector of the present invention comprises: a light source; an optical-fiber biosensor unit having a well, a coating layer, and a core layer; an optical detector; a plurality of optical fibers connecting with the light source, the optical-fiber biosensor unit and the optical detector; and a calculation and display unit connecting with the optical detector, wherein the optical detector receives the optical signals from the optical detector and display the calculation results thereof.

Thus, because the SPR detector of the present invention transmits optical signals between the light source, the optical-fiber biosensor unit, and the optical detector, instead of transmitting the optical signals in the atmosphere, the SPR detector of the present invention is able to sustain certain intensity of impacts without damaging the stability of the light path thereof, the volume of the SPR detector of the present invention can be further reduced, and the portability thereof can be further increased. In addition, the optical-fiber biosensor unit of the SPR detector of the present invention is connected with two the multi-mode optical fibers, which connects with the light source and the optical detector through two optical fiber connectors. As a result, when detecting bimolecular samples with the SPR detector of the present invention, there is no need to cease the operation of the SPR detector to change the light path thereof. Instead, a replacement of different optical-fiber biosensor is required. Consequently, the SPR detector of the present invention is not only simple to operate, but also able to accomplish the entire detection process rapidly and accurately.

The light source used in the SPR detector of the present invention can be any conventional light source, preferably a laser diode or an LED. The well of the optical-fiber biosensor unit can be coated with a metal layer made of any kind of material, preferably gold or silver. The SPR detector of the present invention can have any kind of optical detectors, preferably photodiode detectors or CCD detectors. The well of the optical fiber biosensor unit can be manufactured by any conventional process, preferably by side polishing process or etching process. The SPR detector of the present invention can further comprise any kind of temperature detectors for measuring the temperature of the flow well, preferably an electric dipole thermometer. The SPR detector of the present invention can further comprise any kind of temperature controllers for maintaining the temperature of the flow well, preferably a resistance heater or a TE cooler. The SPR detector of the present invention can further comprise a plurality of optical-fiber connectors of any kind for connecting the optical fibers with the optical-fiber biosensor unit, preferably FC type optical-fiber connectors, ST optical-fiber connectors, or LC optical-fiber connectors. A biomolecule layer of any kind can be formed on the surface of the well of the optical-fiber biosensor unit in the SPR detector, preferably the biomolecules are DNA fragments, RNA fragments, peptide fragments or proteins. A biomolecule layer of any kind can be formed on the surface of the metal layer in the SPR detector of the present invention, preferably the biomolecules are DNA fragments, RNA fragments, peptide fragments or proteins. The SPR detector of the present invention can comprise any kind of power supply, preferably a battery set or a plug.

Other objects, advantages, and novel features of the invention will become more apparent from the following detailed description when taken in conjunction with the accompanying drawings.

### BRIEF DESCRIPTION OF THE DRAWINGS

FIG. 1 is a schematic illustration of prior art SPR detectors.

FIG. 2 is the schematic illustration showing the SPR detector of the first preferred embodiment of the present invention.

FIG. 3A is a schematic illustration of the optical-fiber biosensor unit of the SPR detector in the first preferred embodiment of the present invention.

FIG. 3B is a schematic illustration of the optical-fiber biosensor unit of the SPR detector in the first preferred embodiment of the present invention.

FIG. 4A is a schematic illustration showing the detection results obtained by loading dropwise 1 μL DNA-P (DNA probes fragment) and deionized water in the optical-fiber biosensor unit of the SPR detector in the first preferred embodiment of the present invention.

FIG. 4B is a schematic illustration showing the detection results obtained by loading dropwise 5 μL DNA-P (DNA probes fragment) and deionized water in the optical-fiber biosensor unit of the SPR detector in the first preferred embodiment of the present invention.

FIG. 4C is a schematic illustration showing the detection results obtained by loading dropwise 1 μL DNA-T (DNA target fragment) and deionized water in the optical-fiber biosensor unit of the SPR detector in the first preferred embodiment of the present invention.

FIG. 4D is a schematic illustration showing the detection results obtained by loading dropwise 5 μL DNA-T (DNA target fragment) and deionized water in the optical-fiber biosensor unit of the SPR detector in the first preferred embodiment of the present invention.

FIG. 4E is a schematic illustration which integrates FIG. 4A and FIG. 4C.

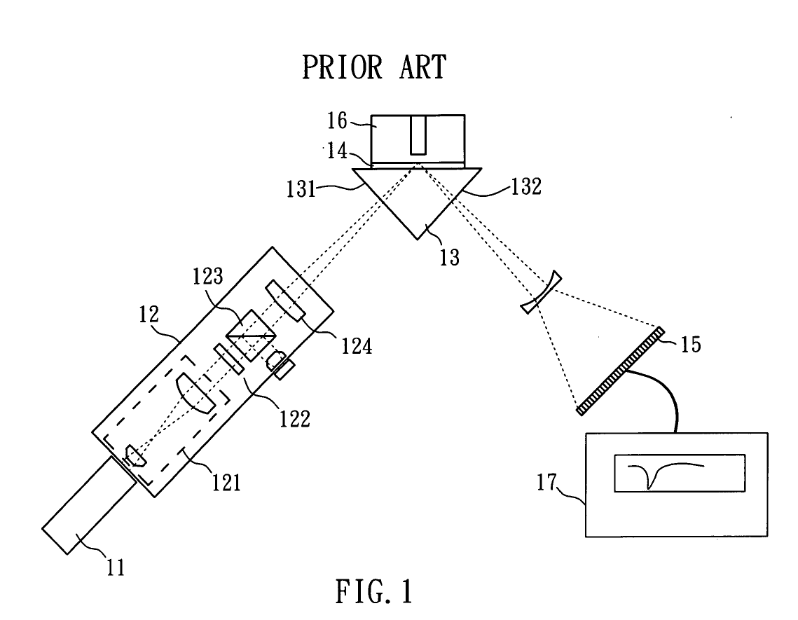

### DETAILED DESCRIPTION OF THE PREFERRED EMBODIMENT

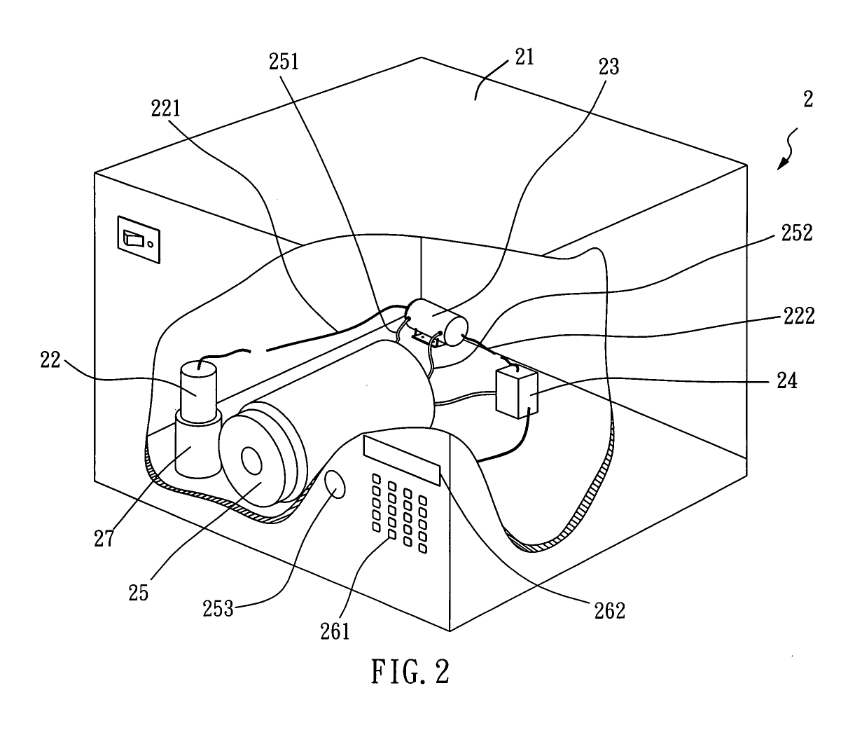

FIG. 2 is a schematic illustration showing the SPR detector of the first preferred embodiment of the present invention. The SPR detector 2 has an outer casing 21, a laser diode 22, a flow well 23, an optical diode detector 24, a solution-loading well 25, a calculation control unit (not shown), and a power supply unit 27, wherein the laser diode 22 provides the laser required for the detection to the flow well 23 through the multi-module optical fiber 221, and the laser light then passing through the detection target in the flow well 23. The laser light carrying the information related to the detection target is then transmitted through another multi-module optical fiber to the optical diode detector 24. Then, the laser light is correspondingly converted to a corresponding electric signal by the optical diode detector 24. The corresponding electric signal is then transmitted to the calculation control unit (not shown), so as to proceed with further calculation. The calculation control unit (not shown) controls the operation of SPR detector 2 of the first preferred embodiment of the present invention and receives the control instructions from outside entering through the button set 261 formed on the surface of the outer casing 21. Besides, the results of calculation by the calculation control unit are displayed on the screen 262 formed on the surface of the outer casing 21. The power for operating of the SPR detector 2 of the present invention is provided by the power supply unit 27, which can be a plug with a transformer or a battery set (applied to the occasions where commercial power supply is not available, such as outdoors detecting application).

In addition, the solution-loading well 25 is loaded with a solution that can provide a suitable environment for the detection, the solution flows in and out through duct 251 and duct 252, respectively, such that the flow well 25 is maintained in a stable state (e.g., at a state with a certain temperature, pH of refraction index, etc). The solution generally comprises a buffer, such as physiological saline or deionized water. The solution can be introduced into solution-loading well 25 through the opening 253. Furthermore, the solution-loading well 25 further comprises a manifold valve (not shown), in order to control the flow of the solution.

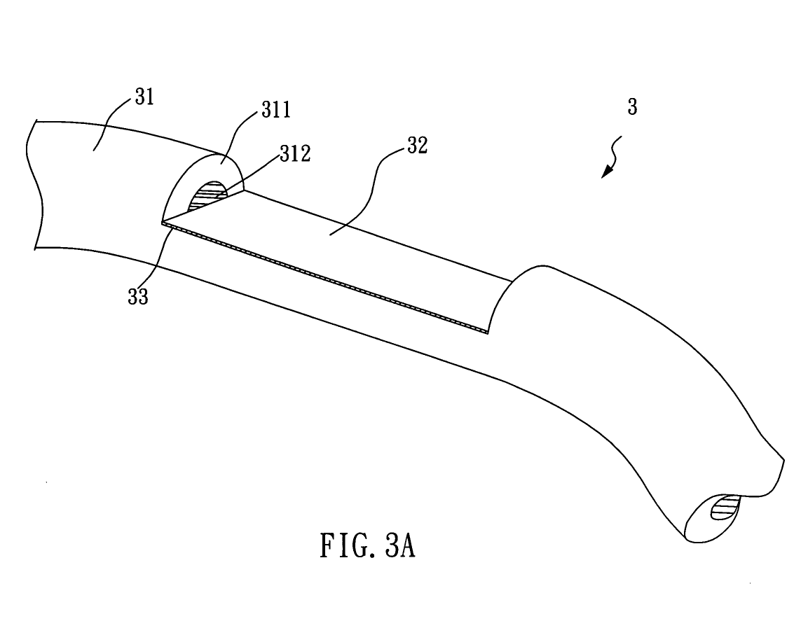

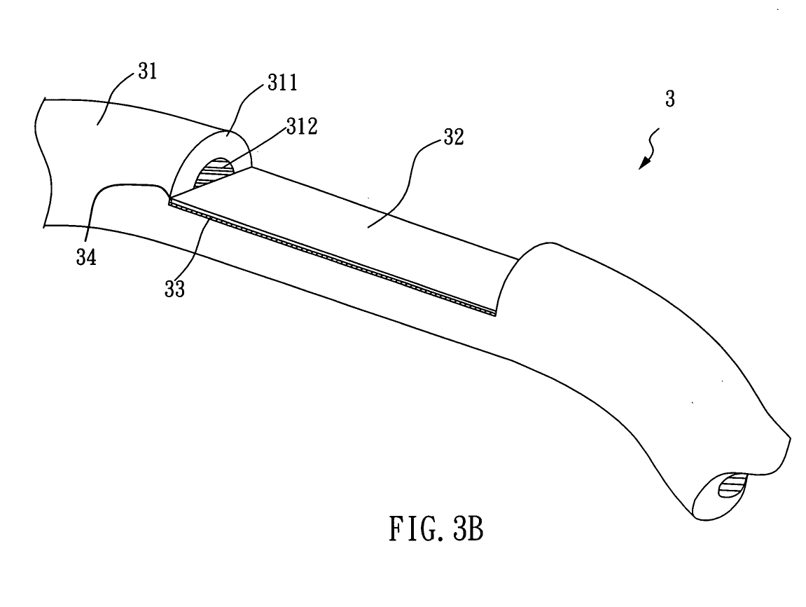

FIGS. 3A and 3B are schematic illustrations of the optical-fiber biosensor unit of the SPR detector in the first preferred embodiment of the present invention, wherein there is no any biomolecules sample attached on the surface of the optical-fiber biosensor unit in FIG. 3A, while there is certain kind of biomolecules sample attached on the surface of the optical-fiber biosensor unit in FIG. 3B. As shown in FIG. 3A, the optical-fiber biosensor unit 3 of the SPR detector of the first preferred embodiment is formed by subjecting the multi-module optical-fiber 31 to a side-polishing process to provide a well 32 (0.5 mm long and 62 μm deep) thereto. The depth is greater than the thickness of the coating layer 311 of the multi-module optical fiber 31, rendering the core layer 312 of the multi-module optical fiber 31 exposed.

It is worth noting that the length and depth of the well 32 are not limited and can be adjusted according to the species of the biomolecule samples and the environment of the detection (e.g., the refraction index of the solution). Besides, to increase the intensity of SPR effects and the binding stability of biomolecule samples, a gold layer 33 can be deposited by the DC sputtering process or the like on the surface of the well 32 (with a depth 43 nm). As shown in FIG. 3B, biomolecule samples (e.g., DNA, RNA, peptides or proteins) are attached to the surface of the gold layer 33, forming a biomolecule layer 34. Note that both ends of the optical biosensor unit 3 have FC optical-fiber connectors, such that it is readily to be connected with the multi-module optical fibers 221 and 222.

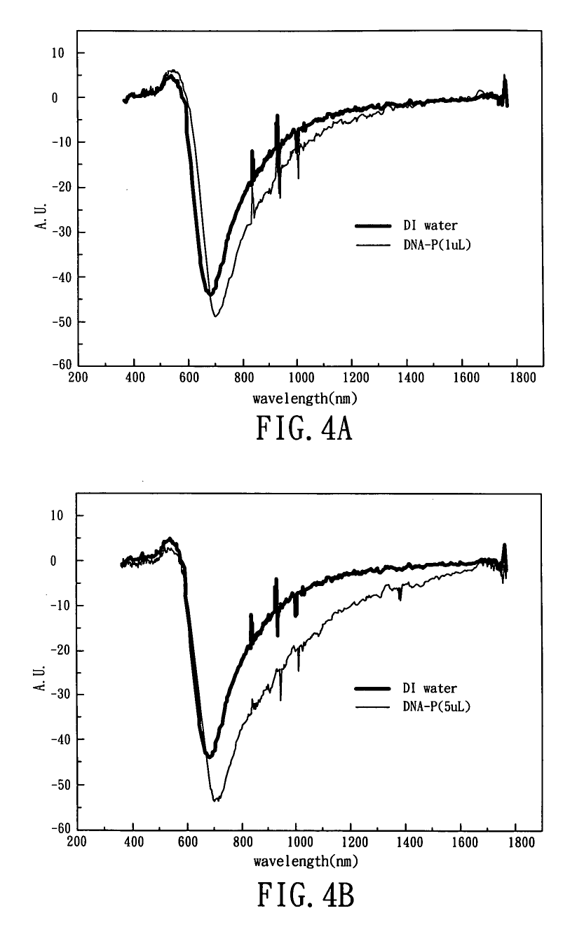

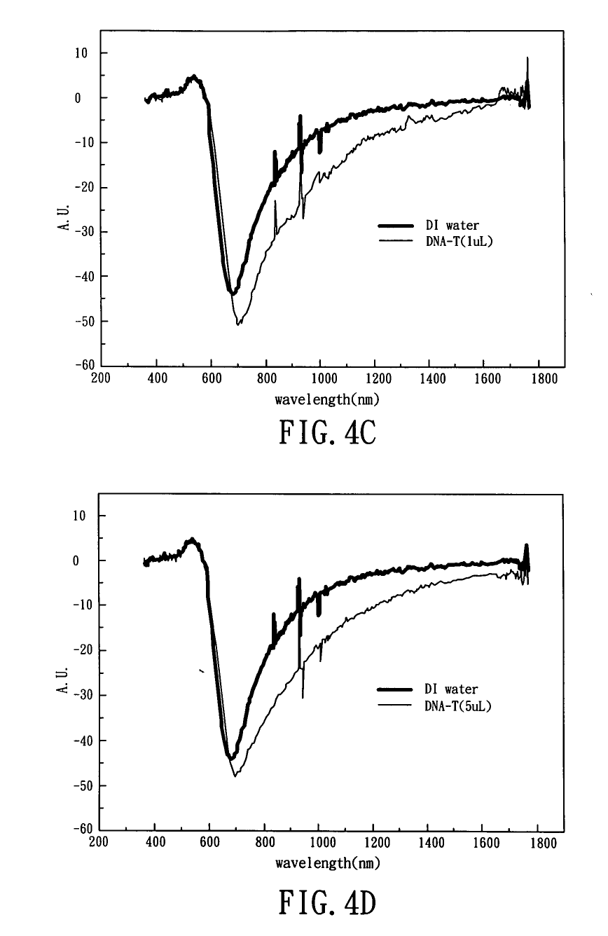

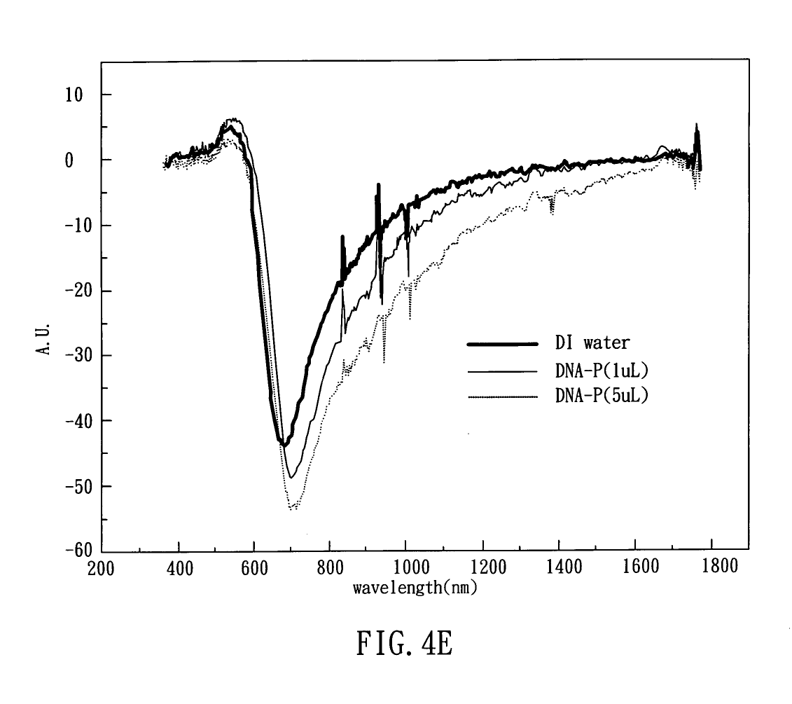

The detection procedures of the SPR detector of the first preferred embodiment of the present invention are described with FIGS. 2 and 4 as follows:

First, the optical-fiber biosensor unit 3 having biomolecule samples (e.g., DNA, RNA, peptides or proteins) is loaded in flow well 23 and connected with the multi-module optical fibers 221 and 222 through the FC optical-fiber connectors. Then, the laser light generated by the laser diode 22 passes through the optical-fiber biosensor unit 3 in the flow well 3 and reaches the optical diode detector 24.

Subsequently, the pump (not shown) is switched on, and the solution continuously flows in and out of flow well 23 through the duct 251 and the duct 252, forming a circulation system. In addition, the solution-loading well 25 further comprises an electric dipole thermometer (not shown) and a TE cooler, in order to measure and maintain the temperature of the solution, respectively. When the temperature of the solution is stable, the laser diode 22 is activated by the calculation control unit and the laser diode 22 emits a laser light having a certain frequency and intensity, which then reaching the optical biosensor unit 3 in flow well 23 through the multi-module optical fiber 221.

At that moment, a surface plasmon resonance effect is generated by the laser light due to the presence of biomolecule samples (e.g., DNA, RNA, peptides or proteins) on the surface of the gold layer 33 formed on the optical-fiber biosensor 3, that is, after passing through the biosensor unit 3, the spectrum distribution of the laser light changes accordingly with the variations of biomolecule samples in species, concentrations, and the action forces between the biomolecule samples and the gold layer 33. The changes in the spectrum of the laser light are described as follows.

As mentioned, the spectrum distribution changes after the laser light has passed the optical-fiber biosensor unit 3, and then the laser light reaches optical diode detector 24 through the multi-module optical fiber 222. The optical signals are then correspondingly converted to electric signals by optical diode 24, then the electric signals are provided to the calculation control unit (not shown) that is connected with the optical diode 24. After proper procedures executed in the calculation control unit (not shown), a spectrum distribution chart is displayed on the screen 262. Alternatively, the species and concentrations of the biomolecule samples can be displayed directly on screen 262, after comparing thereof to database stored in the memory of the calculation control unit (not shown).

FIG. 4A is a schematic illustration showing the detection results obtained by loading dropwise 1 μL DNA-P (DNA probes) and deionized water in the optical-fiber biosensor unit of the SPR detector of the first preferred embodiment of the present invention. Referring to FIG. 4A, though the amount of DNA-P loaded is trace, a significant change in the chart displayed by the SPR detector is observed, comparing to the chart of deionized water (serving as background reference). That is, the peak wavelength increases, and the peak value drops (from −45 A.U. to −50 A.U.). Therefore, only a minimal amount of sample is required for the detection of the SPR detector of the first preferred embodiment of the present invention.

FIG. 4B is a schematic illustration showing the detection results obtained by loading dropwise 5 μL DNA-P (DNA probes) and deionized water in the optical-fiber biosensor unit of the SPR detector of the first preferred embodiment. See FIG. 4B, though the amount of DNA-P loaded is trace (5 μL), a significant change in the chart displayed by the SPR detector is observed, comparing to the chart of deionized water (serving as background reference). That is, the peak wavelength increases, and the peak value drops (from −45 A.U. to −56 A.U.). Therefore, not only a minimal amount of sample is sufficient for the detection of the SPR detector of the first preferred embodiment of the present invention, the sensitivity of the detection is also superior.

FIG. 4C is a schematic illustration showing the detection results obtained by loading dropwise 1 μL DNA-T (DNA target fragment) and deionized water in the optical-fiber biosensor unit of the SPR detector of the first preferred embodiment. See FIG. 4C, though the amount of DNA-T loaded is trace, a significant change in the chart displayed by the SPR detector is observed, comparing to the chart of deionized water (serving as background reference). That is, the peak wavelength increases, and the peak value drops (from −45 A.U. to −52 A.U.). Therefore, only a minimal amount of sample is required for the detection of the SPR detector of the first preferred embodiment of the present invention.

FIG. 4D is a schematic illustration showing the detection results obtained by loading dropwise 5 μL DNA-T (DNA target fragment) and deionized water in the optical-fiber biosensor unit of the SPR detector of the first preferred embodiment. Referring to FIG. 4D, though the amount of DNA-T loaded is trace (5 μL), a significant change in the chart displayed by the SPR detector in the first preferred embodiment is observed, comparing to the chart of deionized water (serving as background reference). That is, the peak wavelength increases, and peak value drops (from −45 A.U. to −52 A.U.). Therefore, only a minimal amount of sample is required for the detection of the SPR detector of the first preferred embodiment of the present invention.

FIG. 4E is a schematic illustration, which integrates FIG. 4A and FIG. 4C, showing that the SPR detector of the first preferred embodiment of the present invention is able to detect trace biomolecule samples and identify the species thereof (DNA-P or DNA-T). Thus, the detection of the SPR detector of the first preferred embodiment not only has high sensitivity, but also can identify the species of trace biomolecules.

To sum up, because the SPR detector of the present invention transmits the optical signals between the light source, the optical-fiber biosensor unit and the optical detector through the multi-module optical fibers, instead of transmitting the optical signals through the atmosphere, the SPR detector of the present invention is able to sustain a certain extent of collision without damaging the stability of optical path thereof. Besides, it is possible to further reduce the size of the SPR detector of the present invention, thereby increasing the portability of the SPR detector of the present invention. Further, since the optical-fiber biosensor unit of the SPR detector is connected with the multi-module optical fibers, which connect with the light source and the optical detector, through the optical fiber connectors, the SPR detector of the present invention can easily detect a variety of biomolecule samples just by changing the optical fiber biosensor units thereof, without the need to shut down the SPR detector for adjusting the light path of the SPR detector. Therefore, the SPR detector of the present invention is not only simple to operate, but also able to complete the entire detection process rapidly and accurately.

Although the present invention has been explained in relation to its preferred embodiment, it is to be understood that many other possible modifications and variations can be made without departing from the scope of the invention as hereinafter claimed.

What is claimed is:

1. A surface plasmon resonance detector, comprising:
a light source;
an optical-fiber biosensor unit having a well, a coating layer, and a core layer;
an optical detector used to detect optical signals passing through the optical-fiber biosensor unit;
a plurality of optical fibers connecting with the light source, the optical-fiber biosensor unit and the optical detector; and
a calculation and display unit connecting with the optical detector, wherein the calculation and display unit receives the optical signals from the optical detector and display the calculation results thereof.

2. The surface plasmon resonance detector as claimed in claim 1, further comprising a flow well for loading the optical-fiber biosensor unit and a solution.

3. The surface plasmon resonance detector as claimed in claim 1, wherein the light source is a laser diode.

4. The surface plasmon resonance detector as claimed in claim 1, wherein the surface of the well is coated with a metal layer.

5. The surface plasmon resonance detector as claimed in claim 4, wherein the metal is gold.

6. The surface plasmon resonance detector as claimed in claim 1, wherein the optical detector is a photodiode detector.

7. The surface plasmon resonance detector as claimed in claim 1, wherein the well is manufactured by applying a side polishing process to an optical fiber.

8. The surface plasmon resonance detector as claimed in claim 2, wherein the flow well is connected with at least one outer duct.

9. The surface plasmon resonance detector as claimed in claim 2, further comprising a pump, wherein the pump is connected with the flow well and the outer duct via at least one pipeline.

10. The surface plasmon resonance detector as claimed in claim 9, further comprises a manifold valve connecting with the pipeline and the outer duct.

11. The surface plasmon resonance detector as claimed in claim 2, further comprising a thermometer for measuring the temperature of the flow well.

12. The surface plasmon resonance detector as claimed in claim 2, further comprising a temperature controller for maintaining the temperature of the flow well.

13. The surface plasmon resonance detector as claimed in claim 1, further comprising a plurality of optical-fiber connectors for connecting the optical fibers with the optical-fiber biosensor unit.

14. The surface plasmon resonance detector as claimed in claim 1, wherein the optical fibers are multi-mode optical fibers.

15. The surface plasmon resonance detector as claimed in claim 2, wherein the solution further comprises a buffer.

16. The surface plasmon resonance detector as claimed in claim 1, wherein the surface of the well is coated with a biomolecule layer.

17. The surface plasmon resonance detector as claimed in claim 4, wherein the surface of the metal layer is coated with a biomolecule layer.

18. The surface plasmon resonance detector as claimed in claim 16 or 17, wherein the biomolecules are DNA fragments or RNA fragments.

19. The surface plasmon resonance detector as claimed in claim 16 or 17, wherein the biomolecules are peptides or proteins.

20. The surface plasmon resonance detector as claimed in claim 1, further comprising a power supply unit.
